(19) United States
(12) Patent Application Publication
(10) Pub. No.: US 2005/0116941 A1
(43) Pub. Date: Jun. 2, 2005

(54) Digital display

(76) Inventor: Oliver Wallington, Cornwall (GB)

Correspondence Address: STITES & HARBISON PLLC, 424 CHURCH STREET, SUITE 1800, NASHVILLE, TN, 37219-2376, US

(21) Appl. No.: 10/495,818

(22) PCT Filed: Nov. 15, 2002
(86) PCT No.: PCT/GB02/05146

(30) Foreign Application Priority Data
Nov. 17, 2001 (GB) 0127597.3

(51) Int. Cl. G09G 5/00

(52) U.S. Cl. 345/184

(57) ABSTRACT

A mobile telephone (1) comprises an LCD (liquid crystal display) screen (2) for visually displaying data items (2a), status and other relevant information to a user. The mobile telephone (1) includes a keypad (3) to enable a user to input information such as numbers or letters, and some functions of the telephone may also be accessed and/or selected by means of the keypad (3). The mobile telephone (1) further comprises a rotary scroller input means (4) located on the side of the telephone for convenient operation thereof by a user. The input means (4) is mounted in the housing of the telephone (1) such that only a portion (7) thereof is visible and accessible to the user externally of the telephone housing. The rest of the input means (4) is mounted within, and obscured by, the housing of the telephone (1). In fact, the ‘invisible’ portion of the input means (4) is located directly behind the display screen (2), with the axis of rotation (6) of the input means (4) being substantially perpendicular to the plane of the screen (2). The “invisible” portion of the input means (4) is represented (both visually and operationally) on the screen (2).

### FIELD OF THE INVENTION

This invention relates to a digital display, and more particularly, to a digital display for providing a human interface in electronic apparatus, such as a mobile telephone, domestic appliance or the like, to display a plurality of items of data for review and/or selection by a user.

### BACKGROUND TO THE INVENTION

There are many different types of electronic apparatus (portable or otherwise) available which include a digital display screen on which might be displayed a plurality of data items or options which can be reviewed and selected as required by a user. For example, mobile telephones generally provide access to a wide range of services and functions from which a user can select. Selection is usually effected using cursor keys or the like incorporated in the keypad of the mobile telephone, or a scroll wheel provided at a convenient position in the telephone housing, operation of which causes a graphical element, such as a highlighter bar or pointer, to move between the listed data items on the screen.

However, the above-described arrangement is not particularly user-friendly, in the sense that there is conceptually and visually limited correlation between the operation of the cursor keys or scroll wheel and the resultant graphical display on the screen, and I have now devised an improved arrangement.

### SUMMARY OF THE INVENTION

In accordance with a first aspect of the present invention, there is provided electronic apparatus including a digital display means for displaying a plurality of data items thereon, the apparatus including mechanical input means for scrolling through, highlighting and/or selecting one or more of said data items, means for producing and displaying a graphical representation of one or more components or elements, said graphical representation being representative of at least a portion of said mechanical input means, or an imaginary portion, element or component thereof, and means for animating said graphical representation in accordance with mechanical operation of said input means so as to at least provide an illusion of connectivity between said input means and said graphical representation.

In accordance with a second aspect of the present invention, there is provided electronic apparatus including a digital display means for displaying a plurality of data items thereon, the apparatus including mechanical input means for scrolling through, highlighting and/or selecting one or more of said data items, at least a portion of said mechanical means being hidden or obscured from view externally of said apparatus, said hidden or obscured portion of said mechanical means, and/or its mechanical operation when in use, being graphically represented and/or displayed on said display means.

The underlying concept of the present invention is thus a literal and animated graphical link between a physical interface and the on-screen graphic being controlled thereby. This provides two main benefits over the prior art, namely that it makes menu systems on (particularly) small screen devices more intuitive with more visual feedback, and that it creates a stronger perceived link between external means and on-screen information.

Thus, the present invention concerns the graphical representation on a display screen of an input means. Some kind of visual representation of the mechanical input means is provided on the screen, which representation is animated to mimic or otherwise represent its mechanical behaviour during operation, giving the impression that the mechanical means and the animated graphic are in fact linked.

In a preferred embodiment of the invention, the mechanical input means are preferably analogue input means, such as one or more rotating wheels (having their axis of rotation movement in line with and/or perpendicular to and/or at any other angle relative to the display screen), one or more sliders (with movement in any direction relative to the screen plane, linear or otherwise), optical, field or other proximity sensing (with such sensing being theoretically possible in any direction relative to the screen plane), tilt or inclination sensing (again in any direction relative to the screen), etc. However, it will be appreciated that whilst the input means may sense analogue movement, it may achieve this in a digital manner, for example, by the use of optical encoders on a rotating disk.

The animated screen graphic may be a representation of just the invisible or obscured portion of the input means but it may in addition include a representation of all or part of the visible portion(s) thereof. The graphical representation of the input means need not necessarily be true representation of the input means, but may include or omit features thereof, while still giving the impression of a mechanical/graphical link between the two. The animated screen graphic may include additional graphical elements on or in association with the graphical representation of the input means to give the impression of a link to other virtual elements or components.

A single electronic device may include one or more digital display means each including one or more input means and graphical representations thereof.

The mechanical input means may be geographically offset from the plane of the display screen such that any visible portion of the input means and its corresponding graphical representation appear to be lined up at the normal angle of operation of the apparatus. Similarly, the graphical representation of the input means displayed on the screen may include perspective and three-dimensional features so as to improve the realism of the graphical representation at least when viewed from the normal or usual angle of operation of the apparatus. Such perspective or three dimensional features may be exaggerated to enhance the illusion of realism and/or to contribute to the aesthetic appearance of the graphic environment.

Although the graphical representation of the input means as displayed on the screen is beneficially of a similar size and scale to the corresponding portion of the input means, so as to maximise the realism of the representation, a different scale or manner of operation of the input means may be provided according to requirements.

Particularly, but not exclusively, in the event that the input means is naturally entirely invisible externally of the apparatus, such as in the case of a tilt, inclination, field or proximity sensing input means, the graphical representation might be representative of its operation in the form of an action which is typical of the action or parameter being sensed. Thus, in the case of a tilt sensing input means, for example, an animated element such as a ball or the like may roll around the screen in accordance with the tilting of the apparatus. In this case, the location on the screen of the ‘virtual’ ball is preferably such that it indicates the data item which is currently highlighted for selection or review. In the case of a proximity sensing input means, the graphical representation of its operation may, for example, comprise a ‘virtual’ shadow which appears to pass over the screen as a user passes their hand thereover. Again, the location of the shadow on the screen may be indicative of the data item which is currently highlighted for selection or review.

It will be appreciated that the input means may comprise one or more of a plurality of different types. For example, the input means may comprise one or more sliders (linear, curved, complex curve movement, etc), or rotary sensors, for example.

Such sliders or rotary sensors may use:
1. Contact to electrically varying resistive element (gives analogue electrical value).
2. Pressure applied to strain measuring element (strain gauge, changes electrical resistance).
3. Light level sensing (light is reflected or varied by movement of slider, this is sensed and converted into either power or resistive electrical quantity).
4. Incremental electrical contacts (a plurality of contacts/electrical switches along movement axis).
5. Multiple camon single electrical switch (slider has ridges or similar and repetitively activates a single switch whilst moving, this is counted to calculate position).
6. Optical encoding (as above but repetitively breaking a light beam) (a plurality of the above can assist in obtaining direction/end point data).
7. Magnetic switching (magnetic elements on or near sliding portion can be sensed to give position data, reed switches or hall effect sensing).
8. Magnetic hynamo effect (moving magnetic in relation to coil to create quantity of electrical power which can be measured).
9. Piezoelectric effect (pressure upon piezoelectric crystals creates measurable electrical charge which can be measured) (a few can be used to simulate multiple cam effect described above).
10. Capacitance proximity sensing (measuring position of object by how much generated electric field is leaked through it, can sense proximity and position of human body parts)(also similar is using a leaking static charge).

The above can be mixed in many ways and can have more than one axis of sensing, eg as in the case of a joystick.

Due to cost, reliability and power consumption issues in mobile electronics in particular, options 1, 2, 4 and 5 above, might, in many cases, be considered to be most advantageous (in view of the fact that they do not generally increase the power consumption of the overall apparatus, although option 6 is also considered to be advantageous as it is very durable and offers great accuracy.

The apparatus beneficially includes computation means for determining the true position of the input means and equating such positional information to means for altering the graphical representation thereof on the display screen.

Such computational means may comprise, for example:
1. Dedicated electronics. An electronic/electrical process can interface input means to display such that the process lies in the behaviour of the components rather than a software element. This process could be digital or analogue.
2. Programmable electronics. An electronic “processor” can interface input means to display which uses software or “data” to incrementally process the information. This processor can be dedicated to the described function or in addition “process” other calculations required for the operation of the device as a whole.
This processor could generate the displayed graphics mathematically or access pre-made graphics in digital formation from a data storage area or device (memory), and of course, a mixture of these processes can be used.
Programmable electronics although primarily digital are available now with analogue/digital and digital/analogue signal converters. These often dedicated functions could be used if the sensing means has an analogue electrical output. Some displays too offer effects from an analogue input.

Additional (possible) computation/interface means:
3. Analogue or digital electronic elements/components may be used in addition to primary computation means to “clean” or alter data from input means such that it is in a format more readily “understood” by computation means. Typical functions would be “de-bouncing” (getting rid of contact noise) contact based sensing means, analogue to digital converts (to turn analogue data from input means into a digital form for a microprocessor/controller).
4. As above but for interfacing processor to display. This element may have its own processes to create electrical signals suitable for the display. This element may also change the voltage or current aspects of the incoming electrical data such that it is at a level suitable for display device.

There can be other connections to all of these to activate other processes, the function is not part of a closed system. Pressing input means might also activate a back light or make a telephone call etc. This process could also be reversed in the sense that, for example, an incoming call could make graphic shake a little bit or re-activate after a sleep period.

However, in an alternative embodiment, the sensing and display means could be designed/electrically connected such that no computation means is required. For example, if a slider has ten incremental electrical contacts independently activated as it moves, these, in conjunction with a power means, can directly drive pixels/shaped elements on a display. Other functions or a computational means could be connected to the interconnection between input means and display to further process the position information, but actually have no effect on the function of the idea.

The display means may be any one or more of the following:
1. Liquid crystal display. Uses uniform or shaped areas that generally appear black when electrically activated. Can use mask/filter effects to create illusion of colour. Can have reflective elements so that graphic is observed against a backdrop of reflected light. Could have a back light of some form. Could be predominantly or partially transparent. Active areas alter level of this transparency.
2. Plurality of light emitting diodes (any shape). Could be in a uniform matrix but not necessarily. Can use a range of colours. Shape of individual LED may contribute part or a whole section of displayed graphic.
3. Vacuum display. A sealed transparent chamber which uses electrical reaction with contained gas to create light. Emitters of electrical charge can be shaped such that parts or whole graphics may be displayed.
4. Cathode ray tube. Monochrome/colour.
5. Electro-luminescent segments shaped to form part or whole of portion of graphic. Variety of colours possible. Often used as a back light for LCD screens.
6. Plasma displays.
7. Light projector.
8. Any other suitable display means.

Any of the above display means could be mixed, and/or filtered, reflected or optically altered in any other way such that the result is still a representation of the mechanical input means.

The present invention can be used in any electronic apparatus having a digital display screen, including washing machines, central heating controls, ovens, fridges, and other domestic appliances, electronic toys, game consoles, stereos (home/car/portable), television/stereo remote controls, and similar entertainment based appliances, clocks/watches, mobile/stationary telephones, PDA's, lap tops, etc.

It will be appreciated that the present invention substantially increases the user-friendliness of any electronic apparatus having a digital display screen in the sense that it gives a conceptual and visual correlation between the operation of the user-controlled input means and the data items displayed on the screen.

### BRIEF DESCRIPTION OF THE DRAWINGS

Embodiments of the present invention will now be described by way of examples only and with reference to the accompanying drawings, in which:

FIG. 1 is a schematic front view of a mobile telephone according to an exemplary embodiment of the present invention;

FIG. 2 is a partial view of the mobile telephone of FIG. 1, with a portion of the housing omitted to illustrate the location of the mechanical input means in relation to the graphical representation thereof on the display screen;

FIGS. 3 and 4 are schematic partial views of the mobile telephone of FIG. 1, illustrating the possible operation of the input means;

FIGS. 5A and 5B are front and side views of input means suitable for use in apparatus according to an exemplary embodiment of the present invention;

FIGS. 6A, 6B, 6C, 6D, 6E and 6F are schematic diagrams to illustrate the operation of position sensing means for use in sensing the position of input means in apparatus according to an exemplary embodiment of the present invention;

FIGS. 7A and 7B are graphs illustrating the electrical signal output by the position sensing means of FIGS. 6A-6F, both before and after noise elimination respectively;

FIG. 8 is a schematic block diagram illustrating the main components of apparatus according to an exemplary embodiment of the present invention;

FIGS. 9, 10 and 11 are schematic diagrams illustrating the operation of apparatus according to an exemplary embodiment of the present invention;

FIG. 12 is a partial schematic front view of a mobile telephone according to another exemplary embodiment of the present invention;

FIG. 13 is a partial schematic front view of a mobile telephone according to another exemplary embodiment of the present invention;

FIG. 14 is a schematic front view of a mobile telephone according to another exemplary embodiment of the present invention;

FIG. 15 is a partial schematic front view of a mobile telephone according to another exemplary embodiment of the present invention;

FIG. 16 is a partial schematic front view of a mobile telephone according to another exemplary embodiment of the present invention;

FIG. 17 is a partial schematic front view of a mobile telephone according to another exemplary embodiment of the present invention;

FIG. 18 is a partial schematic front view of a mobile telephone according to another exemplary embodiment of the present invention;

FIG. 19 is a partial schematic front view of a mobile telephone according to another exemplary embodiment of the present invention;

FIG. 20 is a partial schematic front view of a mobile telephone according to another exemplary embodiment of the present invention;

FIG. 21 is a partial perspective view of a mobile telephone according to an exemplary embodiment of the present invention;

FIG. 22 is a partial perspective view of a mobile telephone according to an exemplary embodiment of the present invention;

FIG. 23 is a block diagram illustrating some of the primary processing elements of apparatus according to an exemplary embodiment of the present invention;

FIG. 24 is a partial schematic front view of a mobile telephone according to another exemplary embodiment of the present invention;

FIG. 25 is a schematic front view of input means and display means of apparatus according to another exemplary embodiment of the present invention;

FIG. 26 is a schematic front view of input means and display means for apparatus according to another exemplary embodiment of the present invention;

FIG. 27 is a schematic front view of input means and display means for apparatus according to another exemplary embodiment of the present invention;

FIG. 28 is a schematic front view of input means and display means of apparatus according to another exemplary embodiment of the present invention;

FIG. 29 is a schematic front view of input means and display means of apparatus according to another exemplary embodiment of the present invention;

FIG. 30 is a schematic front view of input means and display means of apparatus according to another exemplary embodiment of the present invention;

FIG. 31 is a schematic front view of input means and display means of apparatus according to another exemplary embodiment of the present invention;

FIG. 32 is a partial schematic front view of input means and display means according to another exemplary embodiment of the present invention;

FIG. 33 is a schematic diagram illustrating how the visual element created by the display may be reflected by optical elements;

FIG. 34 is a schematic front view of input means and display means of apparatus according to another exemplary embodiment of the present invention;

FIG. 35 is a partial schematic front view of input means and display means according to another exemplary embodiment of the present invention;

FIG. 36 is a partial schematic front view of input means and display means according to another exemplary embodiment of the present invention;

FIG. 37 is a partial schematic front view of input means and display means according to another exemplary embodiment of the present invention;

FIG. 38 is a partial schematic front view of input means and display means according to another exemplary embodiment of the present invention;

FIG. 39 is a schematic front view of input means and display means according to another exemplary embodiment of the present invention; and

FIG. 40 is a schematic front view of input means and display means according to another exemplary embodiment of the present invention.

### DETAILED DESCRIPTION OF THE INVENTION

Referring to FIG. 1 of the drawings, a mobile telephone 1 comprises an LCD (liquid crystal display) screen 2 for visually displaying data items 2a, status and other relevant information to a user. In this case, the display 2 is of a typical ‘pixel’ type on which text and graphics are represented by a combination of active picture elements or ‘pixels’. In a manner typical of such devices, the visibility (or transparency) of such pixels is controlled by an electrical input which renders each pixel visible or invisible.

The mobile telephone 1 includes a keypad 3 to enable a user to input information such as numbers or letters, and some functions of the telephone may also be accessed and/or selected by means of the keypad 3.

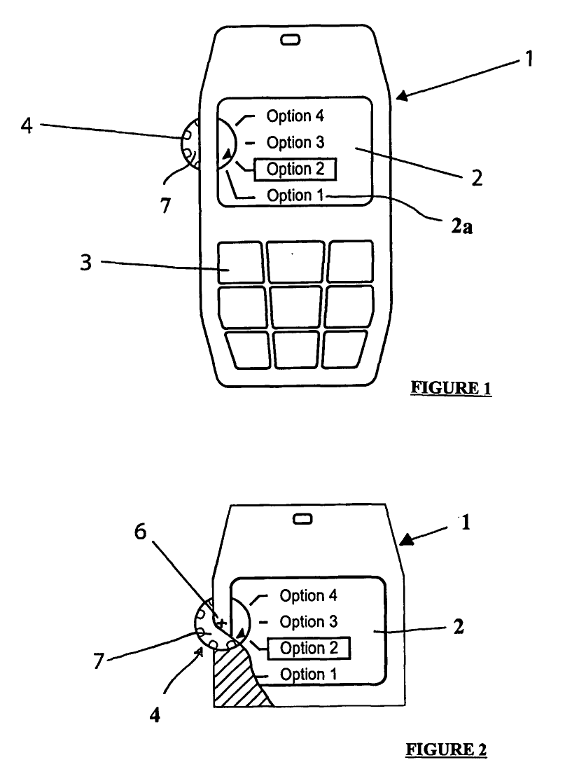

The mobile telephone 1 further comprises a rotary scroller input means 4 located on the side of the telephone for convenient operation thereof by a user. The input means 4 is mounted in the housing of the telephone 1 such that only a portion 7 thereof is visible and accessible to the user externally of the telephone housing. The rest of the input means 4 is mounted within, and obscured by, the housing of the telephone 1 (see FIG. 2). In fact, the ‘invisible’ portion of the input means 4 is located directly behind the display screen 2, with the axis of rotation 6 of the input means 4 being substantially perpendicular to the plane of the screen 2.

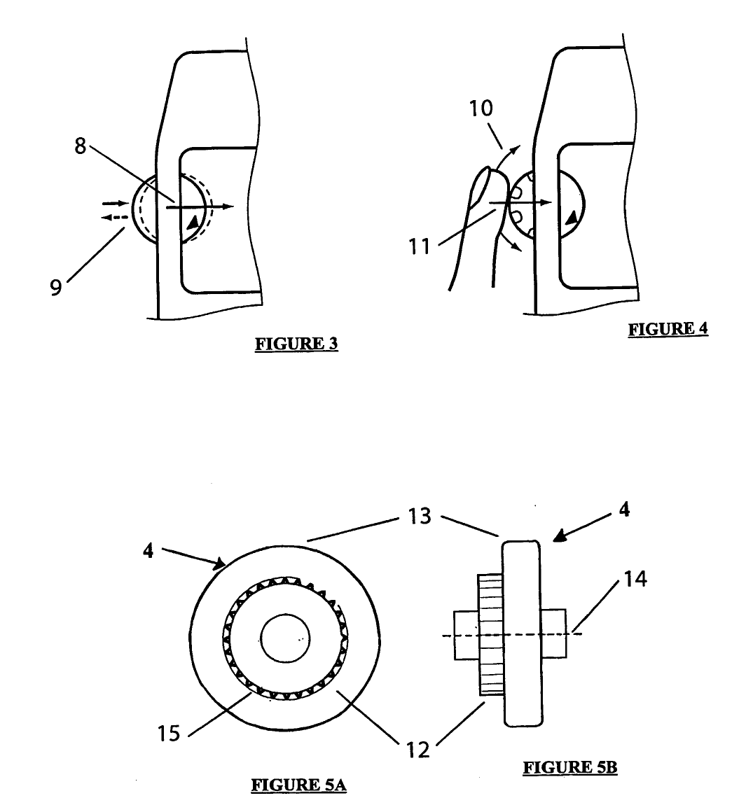

Referring to FIG. 3 of the drawings, the input means 4 has an additional direction of motion which is substantially parallel to the plane of the display 2, as illustrated by the arrow 8. Pressure applied to the input means 4 in the direction of arrow 8, causes the input means to move a short distance in the direction of the arrow 8. The input means 4 is preferably sprung such that withdrawal of such pressure therefrom causes it to return to its original position. As such, the input means 4 in this case can be rotated and/or depressed, either independently or simultaneously, by a user's thumb or forefinger, as illustrated in FIG. 4 of the drawings.

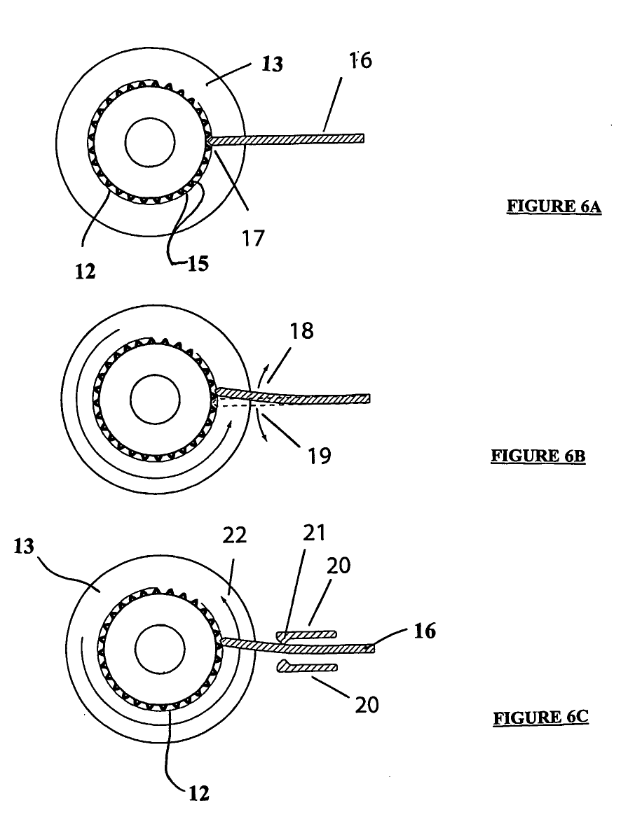

Referring to FIG. 5 of the drawings, the rotary input means 4 comprises a first disc member 13 and a second, smaller disc member 12, the two discs being mounted substantially concentrically about a common axis of rotation 14. The larger disc member 13 is visible and accessible to the user for interacting with the data items displayed on the screen of the electronic apparatus. The smaller disc member 12 is provided with circumferential ridges 15, which are substantially equidistant and extend along its edge in a direction which is substantially perpendicular to the axis of rotation 14.

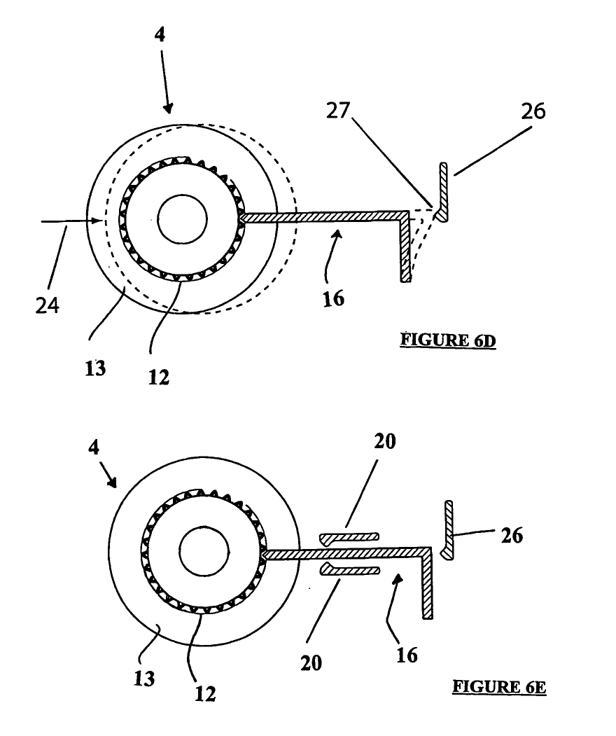

Referring to FIGS. 6A-C, an elongate flexible strip 16 of electrically conductive material (e.g. metal) is mounted such that an end thereof engages with or rests in a space between two adjacent ridges 15 of the smaller disc member 12, as shown. As the disc member 12 rotates (due to manual rotation of the larger disc member 13 by a user), the strip 16 is deflected in a first 18 or second 19 direction (depending on the direction of rotation of the input means 4), and it clears one of the ridges forming the space within which it was resting, and springs or drops back into the next space, as illustrated by FIG. 6B. Referring to FIG. 6C, two electrically conductive elements 20, having contacts 21, are provided on either side of the strip 16, at or adjacent the end opposite that which engages with the smaller disc 12. The elements 20 are mounted such that one of them achieves electrical and physical connectivity with the strip 16 when it is deflected due to rotation of the input means 4, although they are not in contact with the strip when the input means is not in use, i.e. when the strip 16 is resting in one of the spaces between adjacent ridges. It will be appreciated that clockwise rotation of the input means will result in contact between the strip and one of the conducting elements 20, whereas anticlockwise rotation will result in contact between the strip 16 and the other conducting element 20.

A third conducting element 26 is provided proximate the end of the strip 16 opposite the end which rests in the spaces between adjacent ridges of the smaller disc member 12. The strip 16 is, in fact, preferably L-shaped, as shown in FIGS. 6D and 6E, the distal ends of the L-shaped member being fixedly mounted. If the input means 4 (and, therefore, the disc 12) is depressed by the user, corresponding pressure is applied to the distal end of the strip 16 which rests in a space between adjacent ridges of the disc 12, thereby forcing the major length portion of the L-shaped strip 16 to be pushed back and the angle between the two limbs of the strip 16 to be reduced, thus deflecting the corner 27 of the L-shaped strip and causing it to come into contact with the third conducting element 26, as shown. The strip 16 is resiliently flexible, such that when the input means 4 is released by the user, the strip 16 springs back into shape and pushes the disc member 12 (and the rest of the input means 4) back to its original position (FIG. 6E).

Referring to FIG. 6F, the three conducting element 20, 26 are electrically connected and physically held by solder joints 29, 30 on a printed circuit board 31. It will be appreciated that the three conducting elements 20, 26 and the flexible metal strip 16 are preferably electrically connected to computation means (not shown). The combination and/or rate of connections made between the strip 16 and the elements 20,26 received by the computation means enables it to compute (and provide data in electrical form, i.e. switching signals, representative of) the direction of rotation of the input means 4, the speed of rotation, the distance of rotation, pressure on the input means, etc. The input means, flexible strip 16, conducting elements 20, 26 and the computation means will be collectively referred to hereinafter as an “input device”.

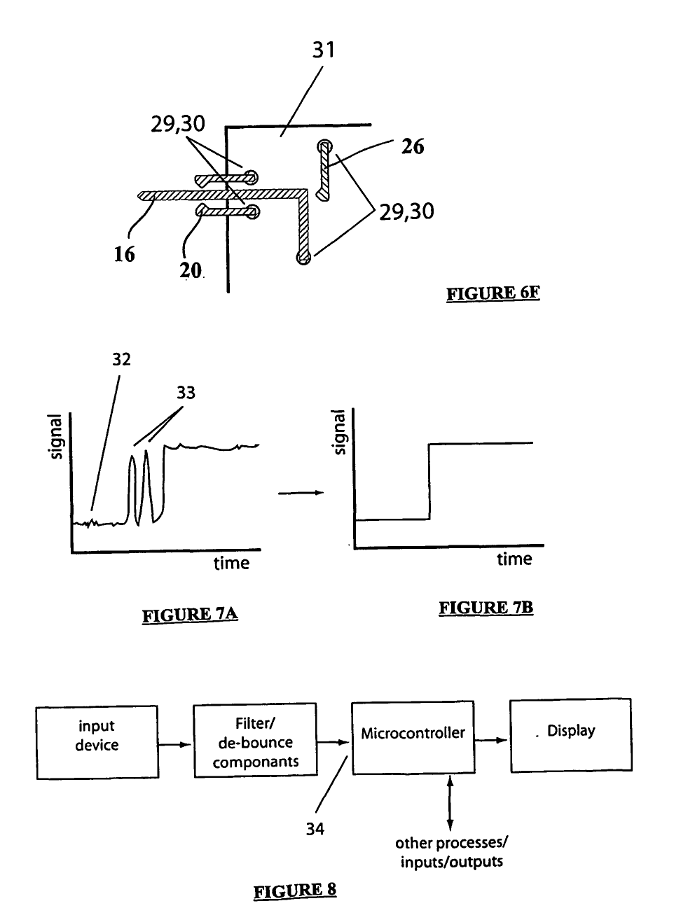

Through electrical connections on the circuit board 31, the electrical switching signals output by the computation means (as illustrated in FIG. 7A) are processed by a filter or the like comprising a mix of passive and active electrical components. It is well known in the art of mechanical switches and the like that capacitive and resistive passive components assist in “cleaning” the signal such that electrical noise 32 and “contact bounce” 33 are reduced. The “clean” signal (as illustrated in FIG. 7B) is then input to a digital processing device or microcontroller 34 (see FIG. 8 of the drawings).

In addition to the other computational tasks required to be performed for the apparatus as a whole, the microcontroller 34 processes the signals produced by the input device. The direction and position of the input means 4 during movement thereof by a user is calculated by counting the electrical “pulses” from the input device. The speed of any such movement can be calculated by comparing the rate or frequency of such “pulses” with an internal clock.

The values of the above-mentioned parameters can be compared with predetermined criteria or threshold values, and further processes or actions may be activated in the event that the predetermined criteria are matched, exceeded or not exceeded, as required. One such criteria may result in the updating of graphics appearing on the screen of the apparatus in the event that any movement or change of position of the input means 4 is detected. The electrical signal from the input device in this exemplary embodiment of the present invention indicates a change of position of the input means 4 (as opposed to its actual position), and the microcontroller is arranged to calculate the actual position from its memory of the previous position together with the data indicating a change of position.

Examples of such processes which may be activated in response to certain criteria being met are:
the highlighting of certain areas on the screen
scrolling through data items in (for example) a virtual phone book
activating (for example) a telephone call
etc.

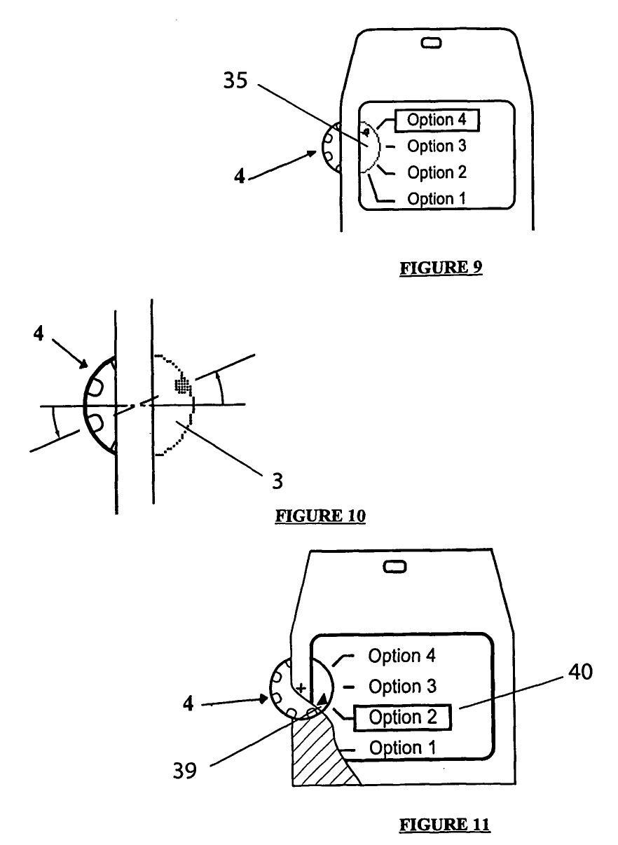

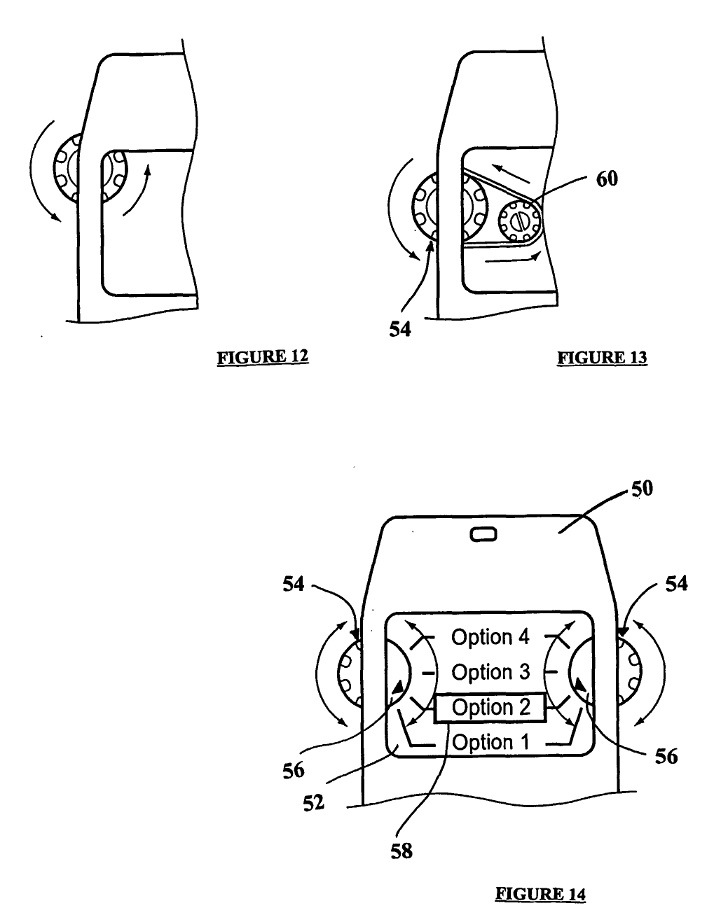

The microcontroller also uses pre-programmed algorithms to generate display data from the position data. The display data includes information that, when transmitted to the display screen, will cause it to create a graphic 35 which visually represents the input means 4 (and/or its operation), as shown in FIG. 9 of the drawings. The programmed algorithms re-calculate signals from the input device when a change has occurred in order to create an animated graphic which behaves “mechanically” in a similar fashion to the input means 4 under the control of the user. The process occurs relatively rapidly such that the graphic 35 appears to move at a speed substantially similar to the actual input means 4 with its visible portion and its graphical representation being substantially coordinated, the graphical representation 35 of the input means 4 appearing to rotate by substantially the same angle as the input means 4, as illustrated in FIG. 10 of the drawings.

As shown in FIG. 11 of the drawings, the input means 4 is positioned such that a portion 39 thereof is behind the screen. The graphic representing the obscured portion 39 of the input means 4 is aligned such that it appears to actually be the portion 39 of the input means 4 obscured by the screen.

The graphic representation of the input means 4 may be visually animatedly linked to other graphics and./or text displayed on the screen. In this case, the graphically represented input means may include a pointer or the like for indicating the data item 40 currently selected or highlighted on the screen.

An embodiment of the present invention has been described above by way of example only and it will be apparent to a person skilled in the art that modifications and variations can be made to the described embodiment without departing from the scope of the present invention as defined by the appended claims.

For example, FIG. 14 of the drawings illustrates a mobile telephone 50 having a display screen 52 and two input means 54, one on each side of the screen 52. Both of the input means 54 comprise rotary discs, a portion 56 of each of which is obscured by the screen 52, and instead graphically and animatedly represented thereon. Either or both of the input means 54 may be used to scroll through, highlight or select one or more data items 58 from a plurality provided on the screen 52.

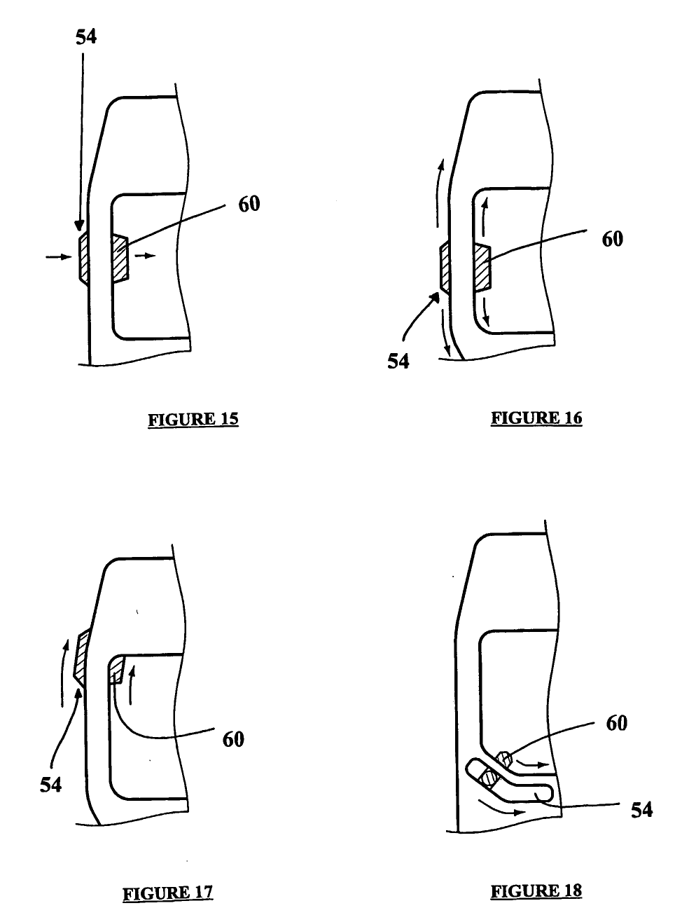

The invention is not intended to be limited with regard to the percentage or size of portion of the input means which is represented on the display screen. This may be dependent on one or more of a number of different factors, including the position of the input means relative to the screen, as illustrated by FIG. 12 of the drawings. Further, the invention is not intended to be limited with regard to the nature of the animated representation of the input means provided on the screen. For example, as illustrated in FIG. 13 of the drawings, the graphical representation 60 of the input means 54 may suggest a mechanical connection therebetween, even though no such connection exists.

The graphical representation of the input means 54 may, of course, represent linear motion (as opposed to, or in addition to, rotary motion), irrespective of the type of motion actually produced by activation of the input means. Thus, as shown in FIGS. 15, 16 and 17 of the drawings, the linear motion of the input means 54 may be accurately represented in the screen graphic 60. In fact, the input means may be arranged to move in a linear manner around the screen, i.e. around the corners, in which case the animated motion of the graphical representation 60 may also involve such motion, as illustrated in FIG. 18 of the drawings. The on-screen graphical representation 60 may be accurately representative of an obscured portion of the input means 54, or it may simply be intended to give the impression of such, i.e. imply a mechanical link between the visible input means 54 and one or more virtual elements.

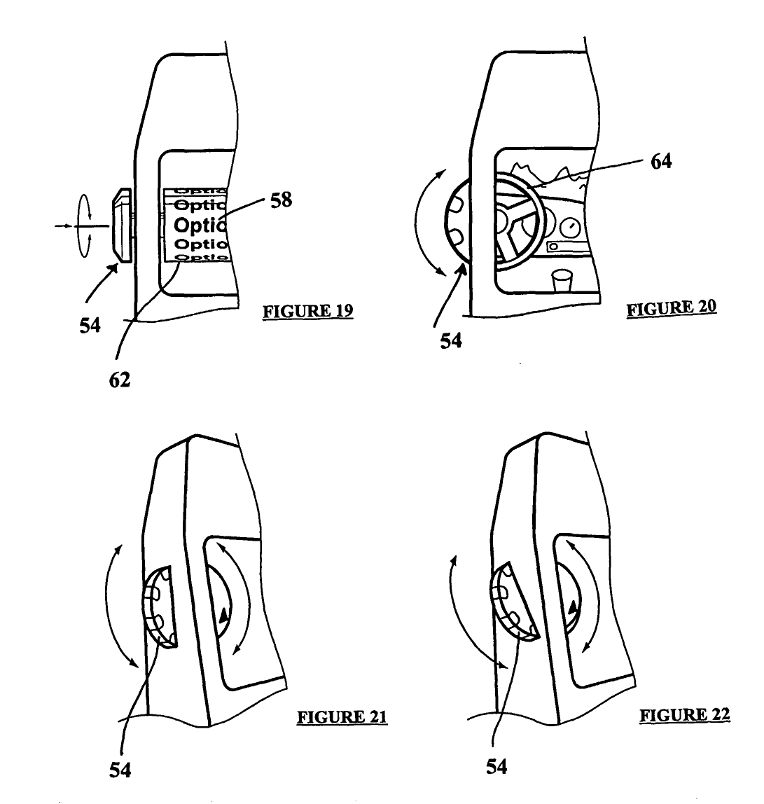

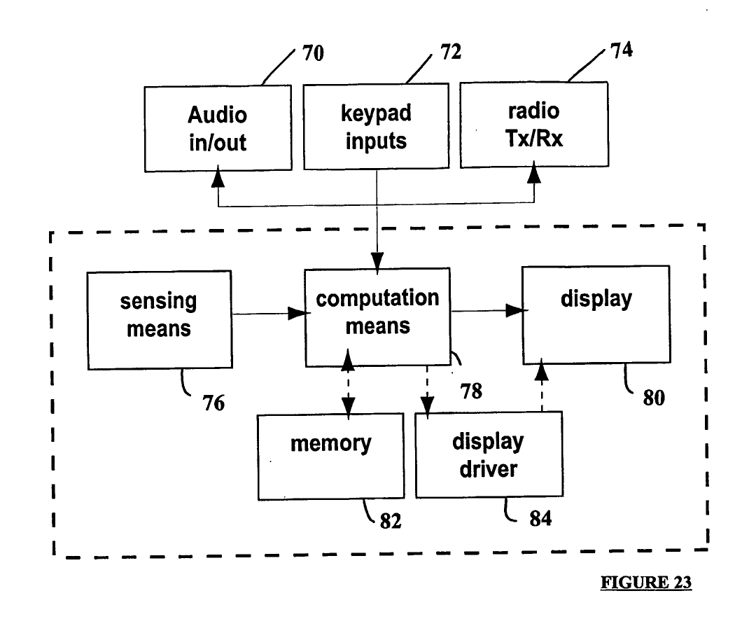

Further examples of the types of graphical representations which may be displayed on the screen are illustrated in FIGS. 19 and 20 of the drawings. In FIG. 19, the data items 58 to be displayed may be provided on a graphically represented roller 62 on the screen. The input means 54 is a rotary wheel, rotation of which results in corresponding rotational movement of the roller 62. In FIG. 20, the obscured portion of the input means 54 is represented on the screen as a steering wheel 64 of a vehicle, the remainder of the scene displayed on the screen being representative of a typical view through a vehicle windscreen. Again, the input means 54 is a rotary wheel or the like, rotation of which results in corresponding animated rotational movement of the steering wheel 64 represented on the screen.

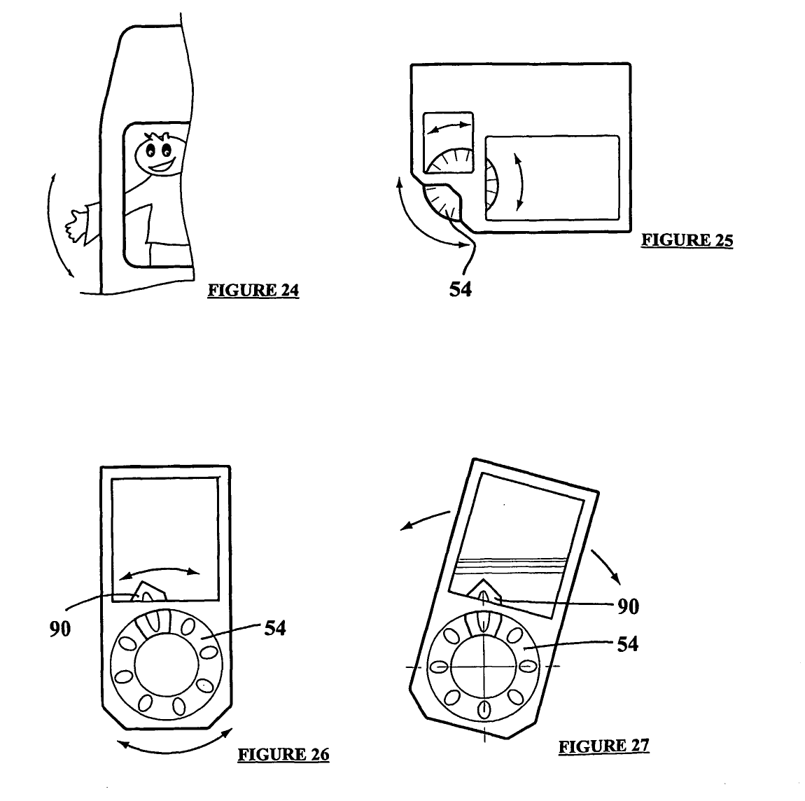

Referring to FIGS. 21 and 22 of the drawings, the input means 54 may be positionally offset from the plane of the screen such that the visible portion of the input means and the graphical representation thereof line up when viewed from an angle at which the apparatus is typically used. Further, the graphical representation of the input means may include perspective and/or three-dimensional aspects such that the graphical representation is a substantially true representation of the input means when viewed from an angle at which the apparatus is typically used.

FIG. 23 is a schematic block diagram illustrating some of the primary process elements which may be included in apparatus according to an exemplary embodiment of the present invention. The audio 70, keypad 72 and radio 74 process functions are relatively standard elements in current mobile telephones and the like and, as such, will not be discussed in any further detail herein. The sensing means 76, senses the position, direction, speed, etc. of movement of the mechanical input means of the apparatus, and its configuration will be dependent upon the nature of the input means itself. The computation means 78 is used for, among other things, determining the movement of the mechanical input means, running the appropriate algorithms to generate corresponding graphics and transmitting the respective outputs for display on the display screen 80 of the apparatus. The memory 82 and the display driver 84 are again relatively standard elements in current mobile telephones and the like, and as such will not be discussed in any further detail herein.

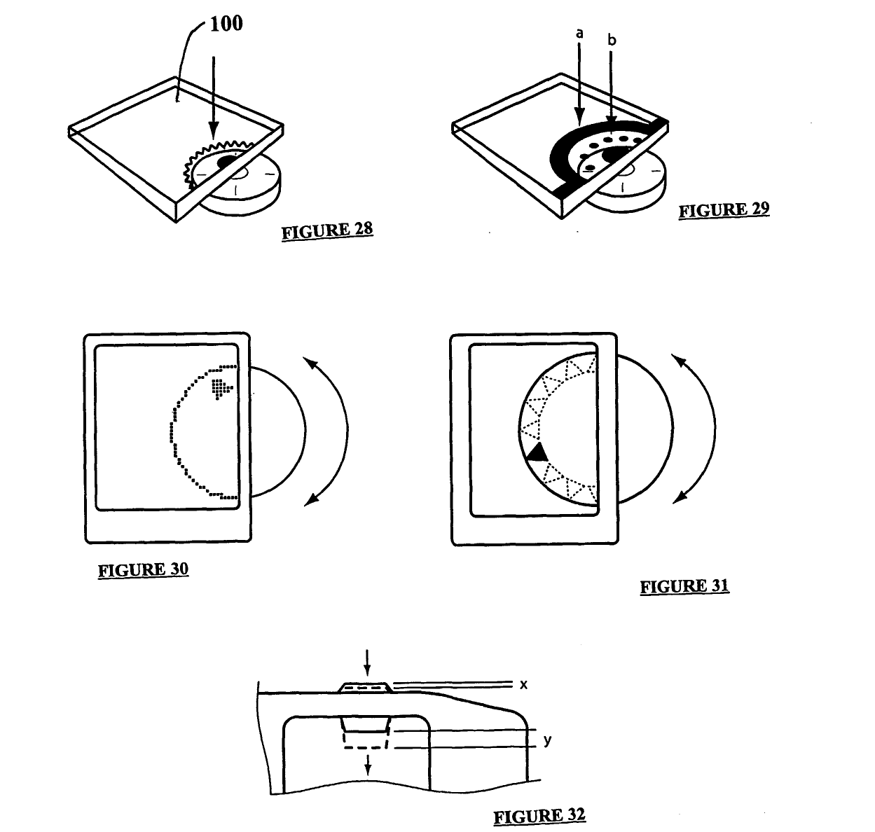

Referring to FIG. 24 of the drawings, the input means may be styled in a manner not related to its function, but still be visually and/or behaviourally related to the on-screen graphic.

Referring to FIG. 25 of the drawings, the input means 54 and/or its operation may be represented on two or more display screens.

Referring the FIG. 26 of the drawings, the input means 54 may be represented on the display screen by a graphical element or component 90 which is not actually a part of the physical input means, although it is animated on the screen to represent the operation of the input means to give the visual impression that it is in fact part of the input means.

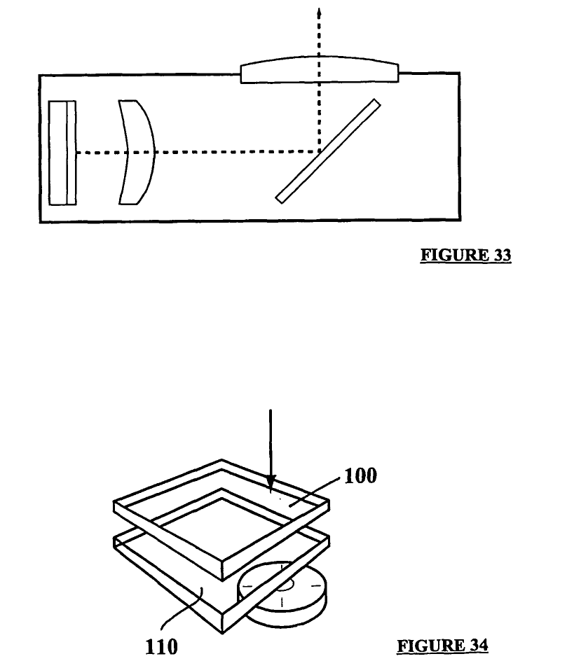

Referring to FIG. 27 of the drawings, the input means 54 may not move with respect to the display screen. Instead, the display screen (and input means) may move relative to a stationary input means. As such, the apparatus may be arranged to graphically display an element or component 90 which is not actually a part of the physical input means (whether internal or external), although it appears to be a part of the external “input means” and is animated on the screen to represent the operation of such input means to give the visual impression that it is in fact part of such input means.

The display screen 100 may be partially or substantially transparent or translucent (see FIG. 28). Such transparency may be inactivated such that information can be displayed on a substantially opaque screen. As a result, the image of the input means viewed on the screen may be a mixture of actual input means with a “virtual” graphic overlaid. Selectively transparent liquid crystal displays are known in the art.

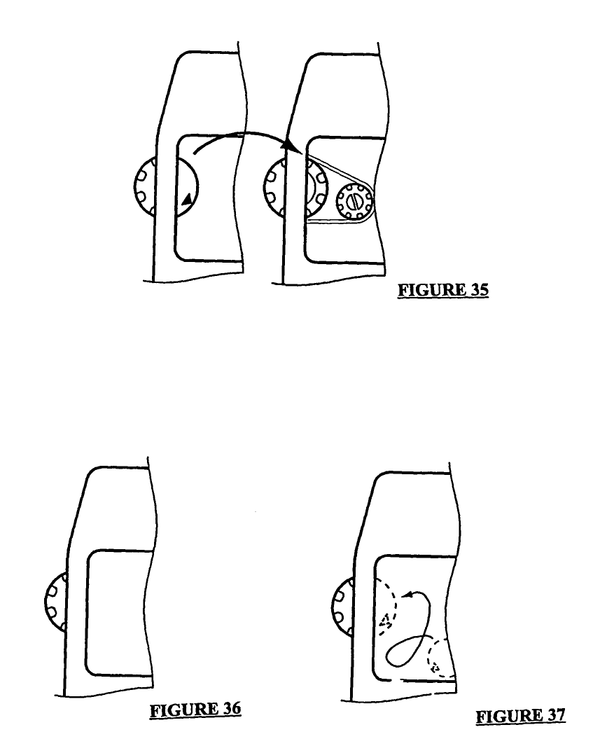

Referring to FIG. 29 of the drawings, portions of the image displayed on the screen may be an inactive graphic, ie. painted on or a mask of some form, which may be an unbroken shape (a) or dots (b), for examples.

It will be appreciated that the graphical representation of the input means may be distorted due to a relatively low screen resolution, as illustrated in FIG. 30 of the drawings.

Referring to FIG. 31 of the drawings, the graphical representation may be instructed from a series of specifically designed shapes which can be activated electronically. In a preferred embodiment, there should be enough of such shapes to create a convincing analogue animation.

Referring to FIG. 32 of the drawings, the animated movement represented by the graphical representation of the input means may amplify true movement of the physical input means. Alternatively, or in addition, movement of the graphical representation could indicate a “force” exerted on the input means, rather than its actual mechanical movement.

The visual element created by the display may be distorted, reflected, polarised, magnified or filtered in some way before reaching the user, as illustrated in FIG. 33 of the drawings. In this case, the input means should be correctly placed in terms of the final viewing angle, but not necessarily in line with the actual means for producing visual information.

Referring to FIG. 34 of the drawings, the graphical representation of the input means may be rendered on a plurality of displays 100, 110, which combine to create a final graphic image. Graphics not related to the input means representation may also be presented on one, some or all of the displays which combine in this manner.

Referring to FIG. 35 of the drawings, the graphical representation of the input means may alter visually to link more closely to other graphics or data on different virtual pages displayed on the screen, ie the default first page may be very simple, the main menu page may have a simple simulated mechanical link to the input means, and again page may have a representation graphic with, for example, steering wheel attributes, or the like.

The graphical representation of the input means may disappear partially or entirely if the device as a whole goes into a power off or standby mode, as illustrated by FIG. 36 of the drawings. It may also be arranged to partially or entirely disappear, distort etc. to make display space for other displayed information, for example, long SMS texts, WAP pictures, etc.

Referring to FIG. 37 of the drawings, the graphical representation of the input means may distort or move in a dissimilar manner to the input means to create, for example, entertaining animation in certain cases, such as switching the power on and/or off, virtual page transitions, etc. This may also occur at predetermined intervals of time for entertainment purposes and the like.

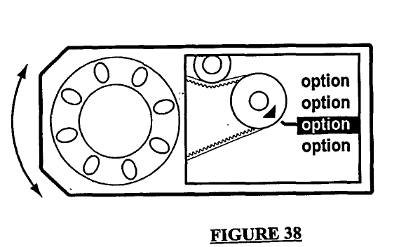

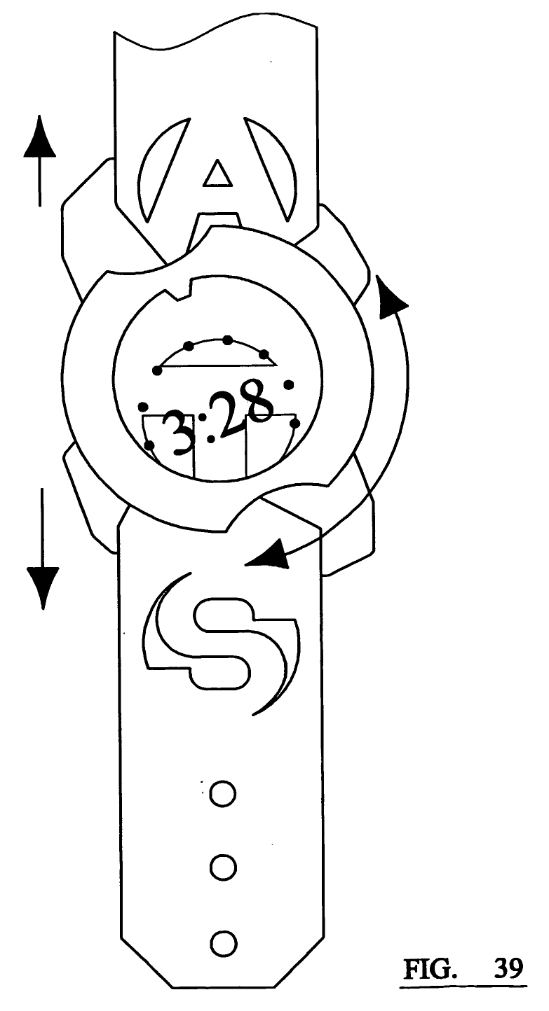

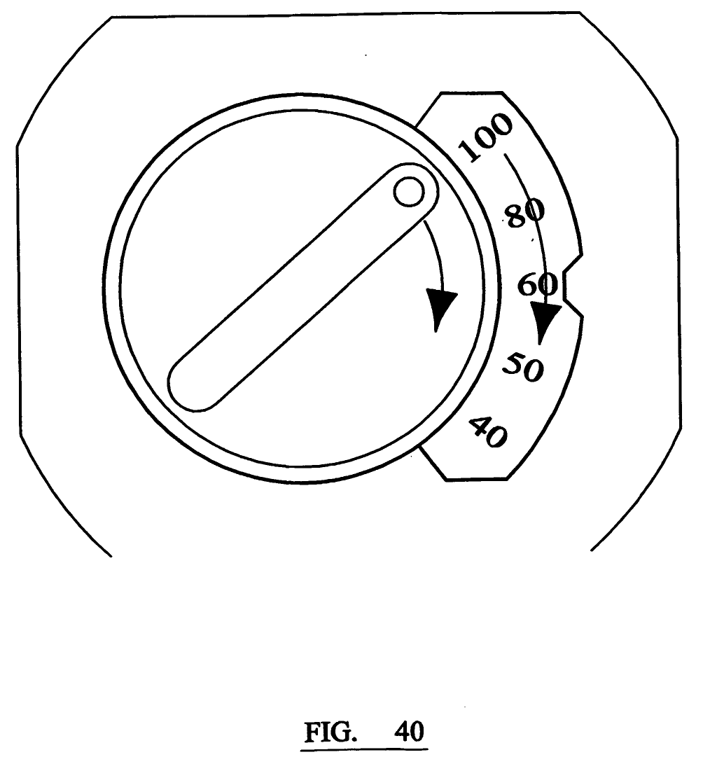

FIG. 38 illustrates the case whereby data items are linked to and highlighted according to the position of a pulley-like graphic on the screen, the rotary operation of which appears to follow the corresponding movement of the rotary input means.

FIG. 39 illustrates an example of the present invention when applied to a wristwatch or the like. Mechanical rotary or linear movement of the watch face results in corresponding movement of the graphical display thereon.

Finally, FIG. 40 illustrates an example of the present invention when applied to a washing machine or similar appliance. As shown mechanical rotary movement of the dial results in a corresponding graphical indication of the selected parameter (such as, in this case) wash temperature.

1. Electronic apparatus including a digital display means for displaying a plurality of data items thereon, the apparatus including mechanical input means for scrolling through, highlighting and/or selecting one or more of said data items, means for producing and displaying a graphical representation of one or more components or elements, said graphical representation being representative of at least a portion of said mechanical input means, or an imaginary portion, element or component thereof, and means for animating said graphical representation in accordance with mechanical operation of said input means so as to at least provide an illusion of connectivity between said input means and said graphical representation.

2. Electronic apparatus according to claim 1, wherein the mechanical input means are analog input means.

3. Electronic apparatus according to claim 2, wherein said analog input means comprises one or more rotating wheels having their axis or axes of rotation in line with and/or perpendicular to and/or any other axis relative to said display screen.

4. Electronic apparatus according to claim 1, wherein said mechanical input means comprises tilt and/or inclination sensing means, in any direction relative to said display screen.

5. Electronic apparatus of claim 1, wherein the graphical representation of said input means is a representation of just the invisible or obscured portion of the input means thereof.

6. Electronic apparatus of claim 1, wherein the graphical representation of the input means includes a representation of all or part of a visible portion of said input means.

7. Electronic apparatus of claim 1, wherein the graphical representation of the input means includes additional graphical elements on or in association with the graphical representation of the input means to give the impression of a mechanical link to other virtual elements or components, which may be representative of mechanical elements which physically exist but are obscured, or elements which do not physically exist with their presence being implied by said graphical elements.

8. Electronic apparatus of claim 1, including one or more digital display means each including one or more input means and graphical representations thereof.

9. Electronic apparatus of claim 1, wherein the mechanical input means are geographically offset from the plane of the display screen such that any visible portion of the input means and its corresponding graphical representation appear to be lined up at the normal angle of operation of the apparatus.

10. Electronic apparatus of claim 1, wherein the graphical representation of the input means displayed on the screen includes perspective and/or three dimensional features, which may be exaggerated to enhance the illusion of realism and/or to contribute to the aesthetic appearance of the graphic environment.

11. Electronic apparatus of claim 1, wherein the graphical representation of the input means is representative of its operation in the form of an action which is typical of the action or parameter being sensed.

12. Electronic apparatus of claim 1, including computation means for determining the true position of the input means and equating such positional information to means for altering the graphical representation thereof on the display screen.

13. Electronic apparatus including a digital display means for displaying a plurality of data items thereon, the apparatus including mechanical input means for scrolling through, highlighting and/or selecting one or more of said data items, at least a portion of said mechanical means being hidden or obscured from view externally of said apparatus, said hidden or obscured portion of said mechanical means, and/or its mechanical operation when in use, being graphically represented and/or displayed on said display means.

14. (canceled)

15. Electronic apparatus of claim 2, wherein the analog input means includes a slider.

16. Electronic apparatus of claim 15, wherein the slider is a linear slider, curved slider, complex curve movement slider.

17. Electronic apparatus of claim 2, wherein the analog input means comprises optical, proximity sensing.
